(19) United States
(12) Patent Application Publication
(10) Pub. No.: US 2025/0193587 A1
(43) Pub. Date: Jun. 12, 2025

(54) ACOUSTIC DEVICE

(71) Applicant: ALPS ALPINE CO., LTD., Tokyo (JP)

(72) Inventor: Ryo ITO, Fukushima (JP)

(21) Appl. No.: 18/970,238

(22) Filed: Dec. 5, 2024

(30) Foreign Application Priority Data
Dec. 6, 2023 (JP) 2023-206314

(51) Int. Cl. H04R 1/40; H04R 1/02

(52) U.S. Cl. CPC H04R 1/403; H04R 1/025; H04R 1/028; H04R 2201/025

(57) ABSTRACT

An acoustic device includes: a chair; and a speaker attached to the chair, wherein the acoustic device is configured to select and set at least one of a first acoustic operation in which a sound pressure or vibration is applied to a seated person sitting in the chair by emitting sound from the speaker, or a second acoustic operation in which two speakers, each being the speaker, face each other with an interval therebetween, and diaphragms of the two speakers vibrate in a direction the two speakers face each other.

### CROSS-REFERENCE TO RELATED APPLICATIONS

The present application is based on and claims priority to Japanese Patent Application No. 2023-206314 filed on Dec. 6, 2023, the entire contents of which are hereby incorporated by reference.

### BACKGROUND

### 1. Field of the Invention

The present disclosure relates to an acoustic device, in which a speaker is attached to a gaming chair or a chair of an automobile such as a driver's seat or a passenger's seat, and which can apply vibration to a seated person by a sound pressure.

### 2. Description of the Related Art

Japanese Unexamined Utility Model Publication No. 1985-89057 discloses a seat device for an automobile. In this seat device, two bass-sound speakers for sensory experience are used together with a medium-high-tone speaker. The bass-sound speakers for sensory experience are built in a seat cushion and a seat backrest, respectively, so that when bass-sound music is played from the bass-sound speakers for sensory experience, the music can be felt directly from the seating surface to the body by vibration.

Japanese Laid-Open Patent Application No. 2007-82220 discloses an electro-acoustic transducers for seats. In FIG. 3 and paragraphs [0016] to [0018], a device mounted on a seat associated with a video game, a game machine, a vehicle in an entertainment facility, or a vehicle or a truck is described. In this device, an upper outlet of an upper acoustic chamber to which an electro-acoustic transducer is mounted opens near the head of a person seated in the seat. When the electro-acoustic transducer operates, its acoustic energy is delivered from the upper outlet to the vicinity of the person's head, and the acoustic energy can provide sensor stimulus to the seated person by a pressure shock or a pressure wave.

### SUMMARY

An acoustic device including a chair and a speaker attached to the chair is provided, wherein the acoustic device is configured to select and set at least one of: a first acoustic operation in which a sound pressure or vibration is applied to the seated person sitting in the chair by emitting sound from the speaker; or a second acoustic operation in which two speakers face each other with an interval, and diaphragms of the two speakers vibrate in the direction the two speakers face each other.

The acoustic device of the present disclosure is provided with a mounting device configured to respectively mount two speakers to the chair. By using the mounting device, the two speakers are selectively mountable either in a first layout for performing the first acoustic operation, in a second layout for performing the second acoustic operation, or both.

For example, the mounting device includes mounting rails, and a first mounting portion and a second mounting portion orthogonal to each other are continuously formed on the mounting rails. The speakers in the first layout are fixed to the first mounting portion, and the speakers in the second layout are fixed to the second mounting portion.

In the acoustic device according to the present disclosure, a direction in which eyes of the seated person face is a front direction, a reverse direction is a rear direction, and a direction orthogonal to a front-rear direction is a lateral direction. In the first acoustic operation, the speaker located behind the seated person is set to the first layout in which a sound propagating centerline of the speaker is oriented in the front-rear direction. In the second acoustic operation, the two speakers face each other with the sound propagating centerline oriented in the lateral direction, and diaphragms of the two speakers are set to the second layout in which they vibrate in the lateral direction.

Furthermore, in the acoustic device of the present disclosure, the speakers are configured to be respectively disposed at an intermediate-angle position in between the first layout and the second layout.

In the acoustic device of the present disclosure, both of the speaker for performing the first acoustic operation and the two speakers for performing the second acoustic operation may be mounted on the chair. In this case, the two speakers for performing the first acoustic operation may be provided.

In the acoustic device of the present disclosure, the speaker may be arranged on a lower side of a seat surface portion of the chair. In the first acoustic operation, upward vibration may be applied from the speaker to the seat surface portion.

### BRIEF DESCRIPTION OF THE DRAWINGS

FIG. 1 is a perspective view illustrating a state in which two speakers are set in the first layout and the first acoustic operation is possible in the acoustic device according to a first embodiment of the present disclosure;

FIG. 2 is a perspective view illustrating a state in which the two speakers are set in the second layout and the second acoustic operation is possible in the acoustic device according to the first embodiment of the present disclosure;

FIG. 3 is a plan view illustrating a state in which the two speakers are set in the first layout as viewed from above in FIG. 1;

FIG. 4 is a plan view illustrating a state in which the two speakers are set in the second layout as viewed from above in FIG. 2;

FIG. 5 is a partial perspective view illustrating details of a mounting device for attaching a speaker to a chair;

FIG. 6A is a perspective view illustrating a state in which the speaker is attached in the first layout by the mounting device for the acoustic device according to the second embodiment of the present disclosure;

FIG. 6B is a perspective view illustrating a state in which the speaker is attached in the second layout by the mounting device for the acoustic device according to the second embodiment;

FIG. 7 is a perspective view illustrating a rearward view of the acoustic device according to a third embodiment of the present disclosure in which both speakers for performing the first acoustic operation and speakers for performing the second acoustic operation are attached to a chair; and

FIG. 8 is a plan view illustrating a modified example of the acoustic device according to the first embodiment of the present disclosure.

### DETAILED DESCRIPTION OF THE DISCLOSURE

The acoustic devices disclosed in Japanese Unexamined Utility Model Publication No. 1985-89057 and Japanese Laid-Open Patent Application No. 2007-82220 can provide stimulation by vibration to a seated person sitting in a chair when a speaker for bass sounds operates, and can enhances the intensity and increases immersion when playing a game, watching a movie, or listening to music. However, when a game requiring concentration such as when a first person shooter (FPS) is selected, a seated person who is a player is subjected to a vibration, the gameplay is rather hindered. Furthermore, assuming that a chair is in a car cabin, although there are times when a seated driver wants to experience powerful music by receiving vibration, there are also times when the driver wants to concentrate on driving by listening only to music without receiving vibration when driving on a highway, driving at night, or driving on a narrow road.

Japanese Unexamined Utility Model Publication No. 1985-89057 has pointed out that the physical sensation of bass sounds is different between a sitting posture while driving and a sitting posture while taking a rest with the seat backrest inclined, because the distribution of body pressure to the seat cushion and the seat backrest changes, and that the physical sensation obtained is not necessarily comfortable even when the sound quality and volume of the bass-sound speaker are uniform because there is a large difference in the degree of concentration of nerves between driving and resting. As a countermeasure, in the automobile seat device disclosed in Japanese Unexamined Utility Model Publication No. 1985-89057, the output levels of the bass-sound speakers provided in the seat cushion and the seat backrest are individually changed to provide the physical sensation according to the preference of the driver.

However, as disclosed in Japanese Unexamined Utility Model Publication No. 1985-89057, when the output level of the bass-sound speaker is lowered in accordance with the sitting posture of the driver, not only the physical sensation of the driver is lowered, but also a sound pressure level of the bass sound emitted is lowered, and consequently music cannot be heard at an optimum volume.

An object of the present disclosure is to provide an acoustic device configured to select and set an acoustic operation for vibrating a seated person and an acoustic operation for reducing vibration to the seated person without significantly changing the output from the speaker.

In the acoustic device according to each embodiment, a Y1-Y2 direction is the front-rear direction, a Y1 direction is a forward direction in which a seated person sitting in a chair faces, and a Y2 direction is a backward direction. An X1-X2 direction is a lateral direction orthogonal to the front-rear direction, and is a direction in which the two speakers performing the second acoustic operation face each other. The X1 direction is a left direction, and the X2 direction is a right direction. A Z1-Z2 direction is a vertical direction, a Z1 direction is an upward direction, and a Z2 direction is a downward direction.

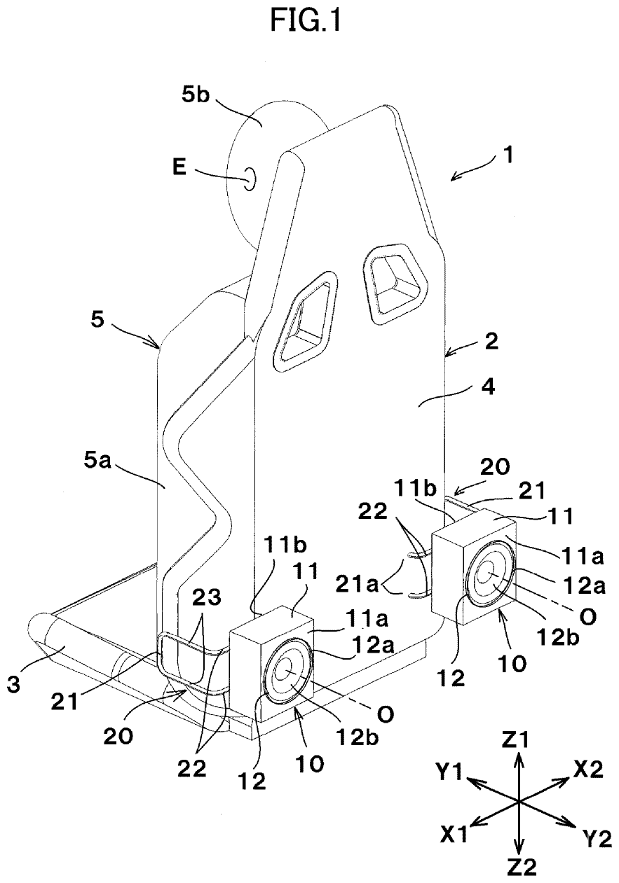

The acoustic device 1 according to the first embodiment of the present disclosure illustrated in FIG. 1 includes a chair 2. The chair 2 can be used for various purposes, including gaming, theatrical halls, movie theaters, and amusement parks. The chair 2 may be a driver's seat, a passenger's seat, etc., in a vehicle cabin. The chair 2 includes a seat surface portion (seat cushion) 3 and a seat backrest portion (back of the seat) 4. In each figure, only a body 5a and a head 5b of a seated person 5 sitting in the chair 2 are illustrated. Left and right ears E are illustrated on the head 5b.

The acoustic device 1 is provided with two speakers 10. Each speaker 10 emits sound in a frequency band of, for example, a middle-low range or a low range. Each speaker 10 includes a casing 11 and a transducer (electroacoustic transducer) 12 fixed to the casing 11. The transducer 12 includes a frame 12a fixed to the casing 11, and the frame 12a is provided with a vibratably supported diaphragm 12b and an electromagnetic transducer. The electromagnetic transducer includes a magnetic circuit section fixed to the frame 12a and a voice coil operating together with the diaphragm 12b. The casing 11 includes a sound-emitting surface 11a and a rear-end surface 11b, and the diaphragm 12b of the transducer 12 appears on the sound-emitting surface 11a. A vibration direction of the diaphragm 12b is a direction in which the sound-emitting surface 11a and the rear-end surface 11b face each other. The speakers 10 can define the vibration direction of the transducer 12 as a sound propagating centerline O. In the casing 11 of the embodiment, the sound-emitting surface 11a and the rear-end surface 11b are planes parallel to each other, and the vibration direction of the diaphragm 12b (a direction in which the sound propagating centerline O is oriented) is perpendicular to the sound-emitting surface 11a and the rear-end surface 11b.

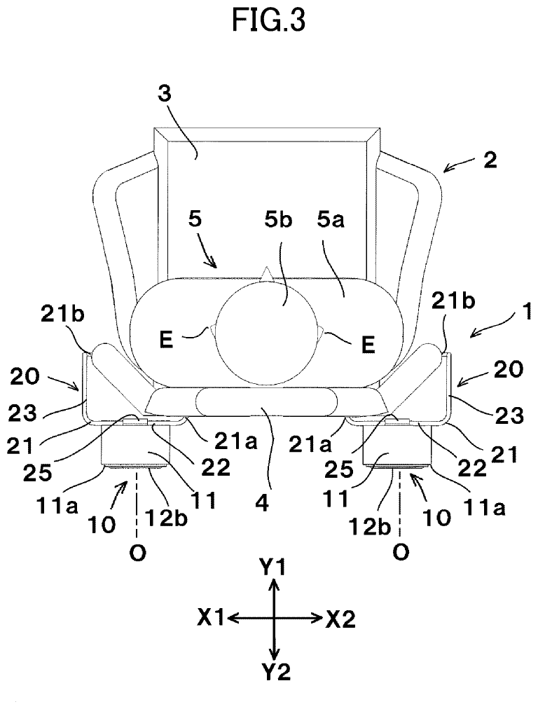

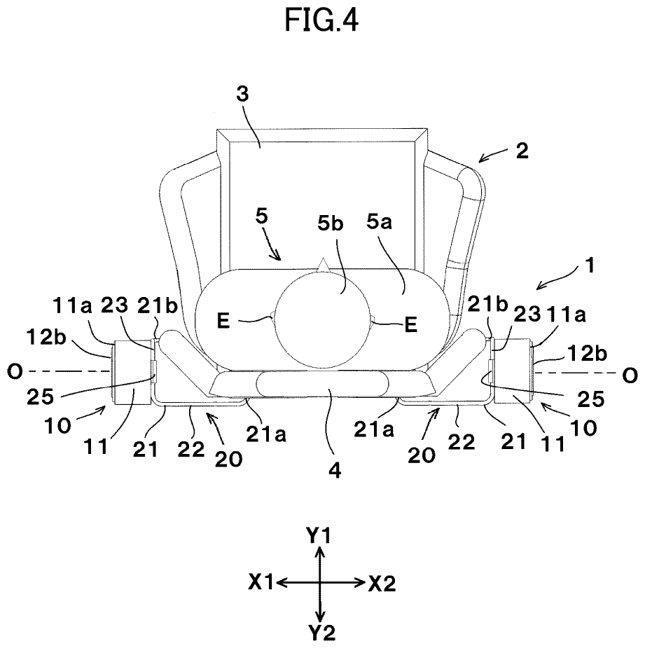

A pair of mounting devices 20 for mounting the two speakers 10 are fixed to a seat backrest portion 4 of the chair 2. Each of the mounting devices 20 includes mounting rails 21. In a plan view of FIGS. 3 and 4, the mounting rails 21 are bent at approximately 90 degrees. As illustrated in FIGS. 1 and 3, the rear fixing portions 21a of the mounting rails 21 are fixed to the rear surface of the seat backrest portion 4 of the chair 2, and the side fixing portions 21b of the mounting rails 21 are fixed to a side surface of the seat backrest portion 4. The mounting rails 21 are arranged in parallel so as to be spaced apart in the vertical direction (Z1-Z2 direction), and have a first mounting portion 22 extending in the lateral direction (X1-X2 direction) and a second mounting portion 23 extending in the longitudinal direction (Y1-Y2 direction).

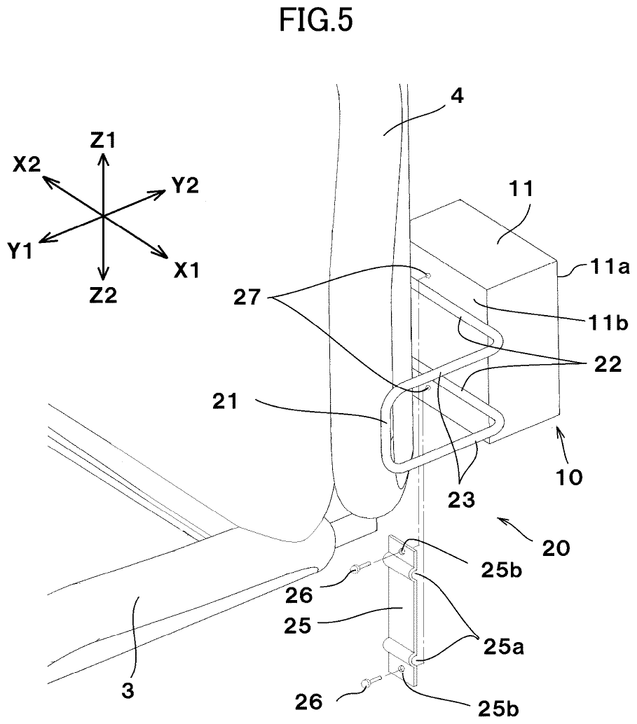

FIG. 5 illustrates a fixing member 25 for fixing the speaker 10 to the mounting rails 21. The fixing member 25 is formed of a metal plate or a synthetic resin plate. The fixing member 25 is formed with a pair of recesses 25a that fit together with an upper and lower rails of the mounting rails 21, and a pair of mounting holes 25b positioned above an upper (Z1 side) recess 25a and below a lower (Z2 side) recess 25a. A pair of female screw holes 27 that correspond to the mounting holes 25b are formed on the rear-end surface 11b of the casing 11 of the speaker 10. When a pair of fixing bolts 26 are inserted into the mounting holes 25b and screwed into the female screw holes 27, the speaker can be fixed to the mounting rails 21 by the fixing member 25.

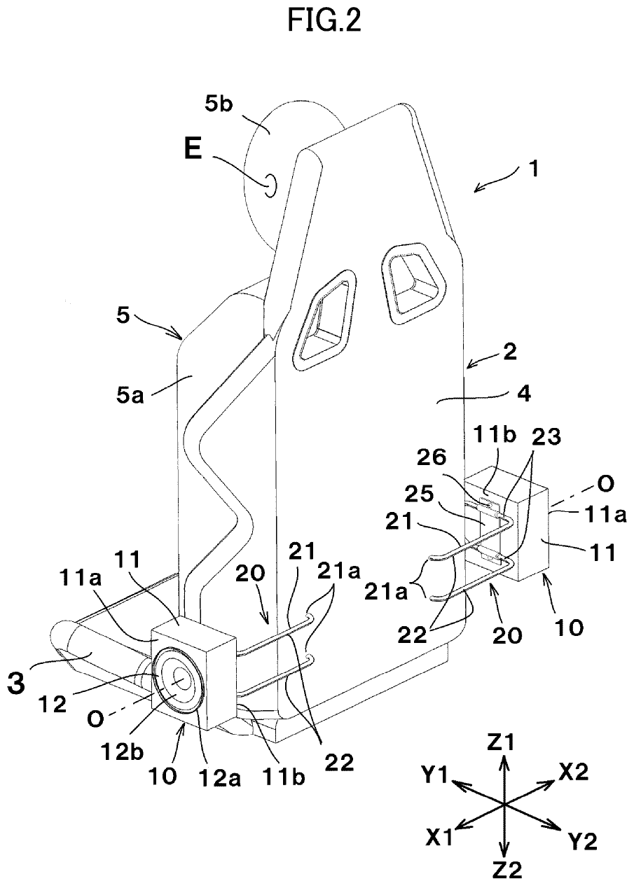

As illustrated in FIGS. 1 and 3, when the speakers 10 are fixed to the respective first mounting portion 22 of the mounting rails 21, the speakers 10 are in the first layout in which the sound propagating centerline O is oriented in the front-rear direction. As illustrated in FIGS. 2 and 4, when the speakers 10 are fixed to the respective second mounting portion 23, the two speakers 10 are in the second layout in which the sound propagating centerline O is oriented in the lateral direction, and the sound is emitted from each speaker 10 toward each other. In the mounting device 20, each of the speakers 10 can be moved along the mounting rails 21 together with the fixing member 25 in a state where the fixing bolts 26 are loosened and the pair of recesses 25a of the fixing member 25 are raised from the two mounting rails 21. After the movement, the fixing bolts 26 are tightened, whereby each of the speakers 10 can be switched from the first layout to the second layout and fixed in place. Conversely, the speakers 10 can be switched from the second layout to the first layout and fixed in place.

Next, setting and operation of the acoustic device will be described. FIGS. 1 and 3 are diagrams illustrating a state in which the acoustic device 1 performs the first acoustic operation. In the left and right mounting devices 20, a pair of speakers 10 are respectively fixed to the corresponding first mounting portion 22 of the mounting rails 21 by the respective fixing member 25, and the two speakers 10 are in the first layout in which the sound propagating centerline O is oriented in the front-rear direction (Y1-Y2 direction). In the casing 11 of the embodiment illustrated in FIGS. 1 and 3, the sound-emitting surface 11a on which the diaphragm 12b is exposed is directed backward (Y2 direction) and the rear-end surface 11b is directed forward (Y1 direction). However, the speaker 10 in the first layout may have the sound-emitting surface 11a directed forward (Y1 direction) and the rear-end surface 11b directed backward (Y2 direction).

As illustrated in FIGS. 1 and 3, when the two speakers 10 are in the first layout, the sound emitted mainly in a backward direction (Y2 direction) by the vibration of the diaphragm 12b of the two transducers 12 reaches the ears E of the seated person 5. Furthermore, since the sound propagating centerline O is oriented in the front-rear direction, the force of the vibration of the diaphragm 12b in the front-rear direction is applied mainly to the body 5a of the seated person 5 from the rear-end surface 11b of the casing 11 via the rail 21 and the seat backrest portion 4. Furthermore, a rearward sound pressure applied to the interior of the casing 11 by the vibration of the diaphragm 12b is also slightly applied to the body 5b from the seat backrest portion 4 through the rear-end surface 11b of the casing 11. In the first acoustic operation of the acoustic device 1, when the two speakers 10 are in the first layout, the seated person 5 can hear the sound, and the sound pressure, the vibration, or both can be felt by the seated person 5 as a physical force. In the first acoustic operation, even when only either of the two speakers 10 with the sound propagating centerline O oriented in the front-rear direction is sounded, the seated person 5 can still feel the vibration. Furthermore, even when only either of the left and right speakers 10 is attached to the chair 2 and used, and the other speaker 10 is removed, the seated person 5 can still feel the vibration in the same way.

FIGS. 2 and 4 are diagrams illustrating a state in which the acoustic device 1 performs the second acoustic operation. In the left and right mounting devices 20, a pair of speakers 10 are fixed in a second layout in which the speakers 10 are fixed to the corresponding second mounting portion 23 of the mounting rail 21 by the respective fixing member 25. The sound propagating centerline O of the speakers 10 in the second layout is oriented in the lateral direction (X1-X2 direction). The diaphragm 12b of the left (X1-side) speaker 10 and the diaphragm 12b of the right (X2-side) speaker 10 vibrate in the lateral direction (X1-X2 direction), which is the direction (alignment direction) the two speakers 10 face each other.

In the second acoustic operation as illustrated in FIGS. 2 and 4, the sound-emitting surfaces 11a of the casings 11 of the two speakers in the second layout are oriented in a direction in which the two speakers face each other, and the left (X1-side) speaker 10 emits sound mainly in the left direction (X1 direction), and the right (X2-side) speaker 10 emits sound mainly in the right direction (X2 direction). Since the directions of the sound emitted from the diaphragms 12b of the two speakers 10 are opposite to each other, a sound pressure emitted mainly in the left direction from the left speaker 10 and a sound pressure emitted mainly in the right direction from the right speaker hardly interfere with each other. Accordingly, the sound from the left speaker 10 easily reaches the left ear E and the sound from the right speaker easily reaches the right ear E of the seated person 5. Therefore, when the levels of the sound output from the two speakers 10 are made equal in the first acoustic operation illustrated in FIGS. 1 and 3 and the second acoustic operation illustrated in FIGS. 2 and 4, the seated person 5 can hear the sound with substantially the same sound pressure in the first acoustic operation and the second acoustic operation.

In the second acoustic operation illustrated in FIGS. 2 and 4, when the left speaker makes a sound, the vibration force of the left diaphragm 12b is transmitted from the casing 11 to the seat backrest portion 4 of the chair 2 via the mounting rail 21, and when the right speaker 10 makes a sound, the vibration force of the right diaphragm 12b is transmitted from the casing 11 to the seat backrest portion 4 of the chair 2 via the mounting rail 21. When a same audio signal is fed to the two speakers in the second layout at the same timing, the vibration acting on the chair 2 from the left speaker 10 and the vibration acting on the chair 2 from the right speaker 10 differ in phase by 180 degrees. Accordingly, the right and left vibrations are mutually canceled and the body 5a of the seated person 5 hardly feels the vibration. Furthermore, even when the audio signals given to the two speakers 10 are different, such as a left channel audio signal of stereo sound is fed to the left speaker 10 and a right channel audio signal is fed to the right speaker 10, since the two speakers are oriented in opposite directions, many components of the vibration acting on the mounting rail 21 from the left and right speakers 10 are easily canceled.

When the chair 2 of the acoustic device 1 according to the first embodiment is used as a gaming chair and gameplay requiring concentration such as when a first person shooter (FPS) is selected, the second acoustic operation illustrated in FIGS. 2 and 4 can be set to perform. In this way, the sound emitted from the speakers 10 can be heard by the ears E and the seated person 5 does not feel a large vibration, making it easier for the seated person 5 to concentrate on the gameplay. When gameplay suited for vibrations is selected, the first acoustic operation as illustrated in FIGS. 1 and 3 can be performed to make the body 5a of the seated person 5 feel the vibration synchronized with the sound from the speakers 10. Furthermore, when the chair 2 of the acoustic device 1 is used as a driver's seat of an automobile, the second acoustic operation can be performed to prevent the seated person 5 from feeling a large vibration when he or she wants to concentrate on driving such as driving at night, driving on a narrow road, or driving on a highway. The first acoustic operation can be performed during other times of driving to make the body 5a of the seated person 5 feel the vibration and enjoy powerful music. When the chair 2 is used in a theatrical hall, a movie theater, an amusement facility, or the like, the first acoustic operation and the second acoustic operation can be accordingly selected and set depending on the program.

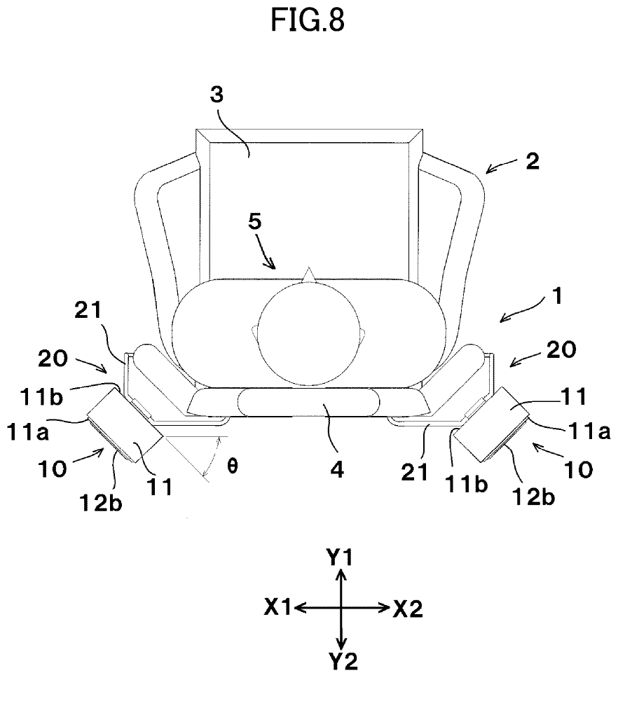

FIG. 8 is a diagram illustrating a modified example of the acoustic device 1 of the first embodiment. The mounting rails 21 of the mounting device 20 used in the present modified example can fix the two speakers to the first layout as illustrated in FIGS. 1 and 3, the second layout as illustrated in FIGS. 2 and 4, and a third layout as illustrated in FIG. 8. In the third layout, the sound-emitting surface 11a and the rear-end surface 11b of the casing 11 of each speaker 10 are disposed in oblique with respect to the lateral direction (X1-X2 direction) by an angle of θ. The angle θ can be set within a range of 30 to 60 degrees, but is set at 45 degrees in FIG. 8. When the speakers 10 are set in the third layout, which is an intermediate position, in terms of angle with respect to the lateral direction, between the first layout and the second layout, and when the output level of the speakers 10 is set to be the same as that of the first acoustic operation, a part of the vibration acting on the chair 2 from the left and right speakers via the mounting rails 21 can be mutually canceled, and thus vibration weaker than that of the first acoustic operation can be applied to the chair 2.

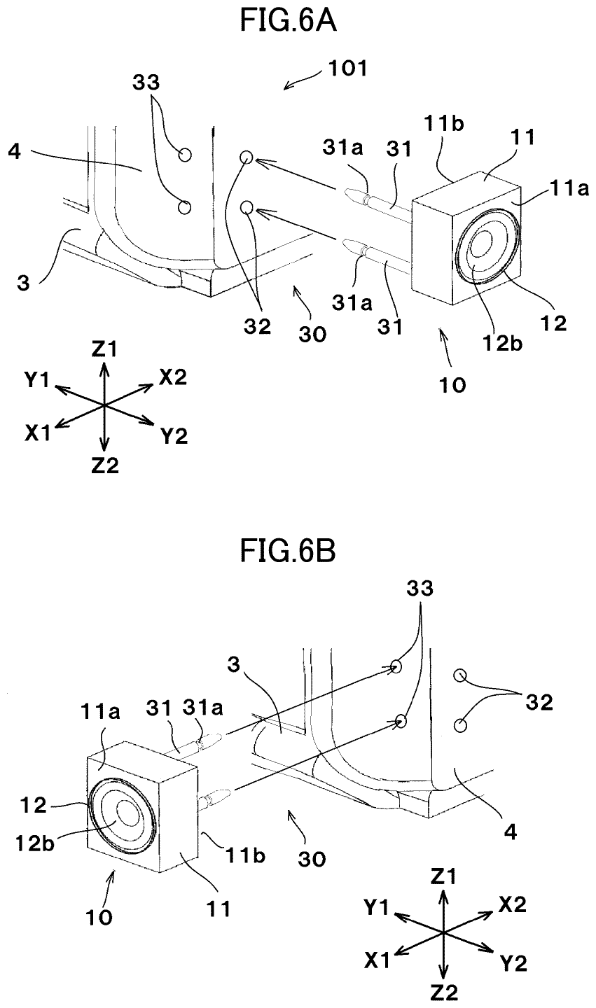

FIGS. 6A and 6B illustrate an acoustic device 101 according to the second embodiment of the present disclosure. The acoustic device 101 includes a mounting device 30 for fixing the two speakers 10 to the seat backrest portion 4 of the chair 2. In the mounting device 30, a pair of upper and lower fixing rods 31 are fixed to the rear-end surface 11b of the casing 11 of the speaker 10. A locking groove 31a is formed at a tip of each fixing rod 31. First mounting holes 32 that open toward the rear direction (Y2 direction) and second mounting holes 33 that open toward the lateral direction (X1-X1 direction) are opened in the seat backrest portion 4 of the chair 2. Locking members fitted into the locking grooves of the fixing rods 31 are provided in the first mounting holes 32 and the second mounting holes 33. A lock/unlock button for releasing the lock by the locking member is provided in the seat backrest portion 4. As illustrated in FIG. 6A, when the fixing rods 31 of the two speakers 10 are inserted into the respective first mounting holes 32 and locked, the speakers 10 are in the first layout and can perform the first acoustic operation. As illustrated in FIG. 6B, when the fixing rods 31 of the two speakers 10 are inserted into the respective second mounting holes 33 and locked, the speakers 10 are in the second layout and can perform the second acoustic operation.

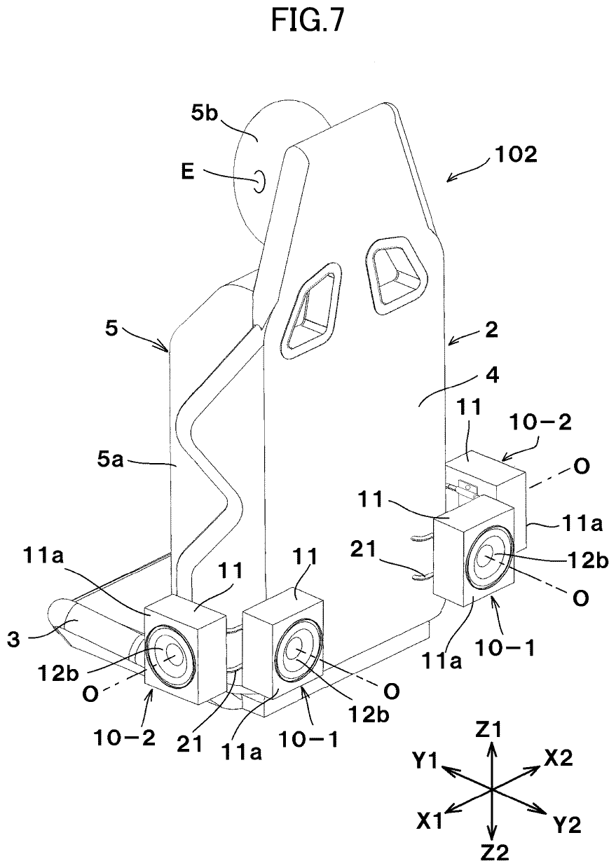

FIG. 7 is a diagram illustrating an acoustic device 102 according to the third embodiment of the present disclosure. In an acoustic device 102, both two speakers 10-1 in the first layout and two speakers 10-2 in the second layout are fixed to the mounting rails 21 of the mounting device 20. The mounting positions of the speakers 10-1 are the same as those of the speakers in the first layout as illustrated in FIG. 1, and the mounting positions of the speakers 10-2 are the same as those of the speakers 10 in the second layout as illustrated in FIG. 2. In the acoustic device 102, by operating the pair of speakers 10-1 in the first layout, a sound pressure and vibration can be applied to the body 5a of the seated person 5, and by operating the pair of speakers 10-2 in the second layout, the seated person 5 can hear the sound with his or her ears E without the seated person's body 5a being subjected to a large vibration. In the acoustic device 102 of the third embodiment, the first acoustic operation can be achieved by selectively operating only the speakers 10-1 in the first layout, without changing the mounting positions of the speakers 10-1 in the first layout and the speakers 10-2 in the second layout, and the second acoustic operation can be achieved by selectively operating only the speakers 10-2 in the second layout.

In the acoustic device 102 as illustrated in FIG. 7, even when only one speaker 10-1 of the first layout is provided, a sound pressure and vibration can be applied from the speaker 10-1 of the first layout to the body 5a of the seated person 5.

In the above-described embodiments, since the sound-emitting surfaces 11a of the pair of speakers 10 or 10-2 of the second layout, in which the diaphragm 12b is exposed from the casing 11, are provided in opposite (repelling) directions to each other in the lateral direction, the sound pressure emitted in the left direction from the speaker on the left side and the sound pressure emitted in the right direction from the speaker on the right side can reach both ears E without significant mutual interference. However, in the second acoustic operation, the diaphragm 12b of the speaker 10 or 10-2 on the left side in the second layout may be oriented in the right direction, and the diaphragm 12b of the speaker 10 or 10-2 on the right side may be oriented in the left direction, so that the diaphragms 12b of the left and right speakers face each other. In this structure, not only the vibrations given to the chair 2 from the left and right speakers are mutually canceled, but also the sound pressure from the left speaker and the sound pressure from the right speaker are readily mutually canceled. Accordingly, the sound reaching the ears of the seated person 5 can be reduced.

In the acoustic device of the present disclosure, in the first acoustic operation, the seated person can hear the sound from the speaker, and also, the sound pressure, the vibration, or both can be applied to the seated person. In the second acoustic operation, the seated person can hear sound from the two speakers, but vibration acting on the seated person can be reduced. The selection of either the first acoustic operation or the second acoustic operation does not cause a large difference in the audible volume. By selecting either the first acoustic operation or the second acoustic operation, it is possible to make a seated person feel vibration or not.

In the present disclosure, the speakers 10 or 10-1 of the first layout may be provided below the seat surface portion 3 of the chair 2, and the sound propagating centerline O of the speakers of the first layout may be oriented in the vertical direction, such that the vibration from the two speakers or one speaker is transmitted to the seated person 5 through the seat surface portion 3 in the first acoustic operation. In this case, the two speakers 10 or 10-2 of the second layout may be provided laterally opposite to each other behind the seat backrest portion 4 of the chair 2 as in the above embodiments, or laterally opposite to each other below the seat surface portion 3.

What is claimed is:

1. An acoustic device, comprising:
a chair; and
a speaker attached to the chair, wherein
the acoustic device is configured to select and set at least one of
a first acoustic operation in which a sound pressure or vibration is applied to a seated person sitting in the chair by emitting sound from the speaker, or
a second acoustic operation in which two speakers, each being the speaker, face each other with an interval therebetween, and diaphragms of the two speakers vibrate in a direction the two speakers face each other.

2. The acoustic device according to claim 1, further comprising:
a mounting device configured to respectively mount the two speakers to the chair, wherein
by using the mounting device, the two speakers are selectively mountable either in a first layout for performing a first acoustic operation, or in a second layout for performing a second acoustic operation.

3. The acoustic device according to claim 2, wherein
the mounting device includes a mounting rail,
the mounting rail being provided with a first mounting portion and a second mounting portion that are orthogonal to each other and are continuously formed with the mounting rail, and
the speaker in the first layout is fixed to the first mounting portion, and the speakers in the second layout are fixed to the second mounting portion.

4. The acoustic device according to claim 1, wherein
a direction in which eyes of the seated person face is a front direction, a reverse direction is a rear direction, and a direction orthogonal to a front-rear direction is a lateral direction,
in the first acoustic operation, the speaker located behind the seated person is set in a first layout in which a sound propagating centerline of the speaker is oriented in a front-rear direction,
in the second acoustic operation, the two speakers face each other with the sound propagating centerline oriented in the lateral direction, and
diaphragms of the two speakers are set in a second layout in which the diaphragms vibrate in the lateral direction.

5. The acoustic device according to claim 2, wherein
the two speakers are configured to be respectively disposed at an intermediate-angle position in between the first layout and the second layout.

6. The acoustic device according to claim 3, wherein
the two speakers are configured to be respectively disposed at an intermediate-angle position in between the first layout and the second layout.

7. The acoustic device according to claim 4, wherein
the two speakers are configured to be respectively disposed at an intermediate-angle position in between the first layout and the second layout.

8. The acoustic device according to claim 1, wherein
both of the speaker for performing the first acoustic operation and the two speakers for performing the second acoustic operation are mounted on the chair.

9. The acoustic device according to claim 8, wherein
two speakers, each being the speaker, configured to perform the first acoustic operation are provided.

10. The acoustic device according to claim 1, wherein
the speaker is disposed on a lower side of a seat surface portion of the chair, and
in the first acoustic operation, an upward vibration is applied from the speaker to the seat surface portion.

11. The acoustic device according to claim 8, wherein
the speaker is disposed on a lower side of a seat surface portion of the chair, and
in the first acoustic operation, an upward vibration is applied from the speaker to the seat surface portion.
